(19) United States
(12) Patent Application Publication
(10) Pub. No.: US 2026/0300536 A1
(43) Pub. Date: Oct. 1, 2026

(54) METHOD FOR IMPLEMENTING NETWORK CONSENSUS ALGORITHM

(71) Applicant: HSBC SOFTWARE DEVELOPMENT (GUANGDONG) LIMITED, Guangzhou (CN)

(72) Inventors: Siyuan JIN, Guangzhou (CN); Yong XIA, Guangzhou (CN)

(21) Appl. No.: 18/880,546

(22) PCT Filed: Oct. 21, 2022
(86) PCT No.: PCT/CN2022/126708

§ 371 Date: Dec. 31, 2024

(30) Foreign Application Priority Data
Jul. 7, 2022 (CN) 202210803895.7

(51) Int. Cl. G06F 21/62; G06F 8/36; H04L 9/00; H04L 41/044

(52) U.S. Cl. CPC G06F 21/6245; G06F 8/36; H04L 9/50; H04L 41/044

(57) ABSTRACT

There is described a computer-implemented method of implementing a modular consensus process for a distributed data processing system, the method comprising selecting, for each predetermined process stage of the consensus process, a process module for implementing the process stage based on impact attributes and a received set of implementation criteria, and generating an implementation specification identifying the selected process modules. The method can enable a suitable consensus process implementation to be generated efficiently in a modular manner with improved flexibility. The method may also include generating software code based on code artefacts associated with the selected process modules.

### FIELD OF THE INVENTION

The present application relates to methods for implementing network consensus algorithms. In particular, the application relates to the modular generation of consensus algorithms for distributed transaction processing systems.

### BACKGROUND OF THE INVENTION

In systems and networks which rely on distributed ledger technology, such as central bank digital currency (CBDC) networks, there is often a need for establishing consensus between nodes of the network. For example, in the case of CBDC networks, at least some of the nodes in those networks must agree on which transactions to commit to a distributed ledger such as a blockchain.

Algorithms exist for achieving consensus within a network, but these are typically pre-defined, off-the-shelf algorithms which are selected on the basis of an overall application. In situations where there is a diverse range of networks with differing characteristics, requirements and applications, these existing approaches for selecting algorithms are too rigid and cannot be adapted easily. Equally, designing new consensus algorithms from scratch for any new scenario is time-consuming. Accordingly, there is a need for a more efficient and flexible approach when implementing consensus algorithms.

### SUMMARY OF THE INVENTION

Aspects of the invention are set out in the independent claims and preferable features are set out in the dependent claims.

There is described herein a computer-implemented method of implementing a modular consensus process for a distributed data processing system, the consensus process arranged to determine consensus between multiple processing nodes of the system, the method comprising:
providing a module database storing information defining, for each of a predetermined set of process stages of the consensus process, one or more process modules for use in implementing the process stage, the information specifying, for each process module, one or more impact attributes, each impact attribute indicating an expected impact of the module on operation of the distributed data processing system with respect to a respective impact dimension;
receiving a set of implementation criteria for the consensus process;
selecting, for each of the predetermined process stages of the consensus process, a given one of the process modules for implementing the process stage, the given process module selected based on the impact attributes specified for process modules in the database and the received implementation criteria; and
generating an implementation specification specifying a consensus process implementation, the specification identifying the selected process modules for each process stage.

Advantageously, using a predetermined set of process stages and selecting a module for implementing each stage can allow a suitable consensus implementation specification to be generated efficiently in a modular manner. In addition, by selecting the modules based on impact attributes and a received set of implementation criteria, a flexible method for determining a consensus implementation is provided.

The method may comprise the steps of: storing in a code library a plurality of code artefacts, each code artefact for implementing a given process module; and generating software code based on code artefacts from the library associated with the selected process modules. The method may further comprise deploying the generated software code to a target system. This can allow efficient (e.g. automated or semi-automated) deployment of census algorithms to a target environment.

The implementation criteria may comprise information defining a target operating architecture of the distributed data processing system. The information defining a target operating architecture may specify a network architecture of the distributed data processing system, specifying one or more of a number of sub-networks, numbers of nodes and/or controlling nodes in the network or in one or more sub-networks, and a tiering architecture arranging sub-networks into a hierarchy. This can allow an implementation specification to be generated taking into consideration specific characteristics of the network architecture of the system. This can also allow separate consensus implementation specifications to be generated for different sub-networks of the system.

The implementation criteria may comprise one or more input parameters associated with the impact dimensions. The input parameters may be received from a user via a user interface. The input parameters may define context characteristics relating to an operational context of the distributed processing system. This can allow the context of the system (e.g. technical limitations of the target environment) to be taken into account when selecting the modules and generating the implementation specification.

The impact dimensions may comprise one or more of: at least one performance dimension relating to technical performance of the distributed processing system, at least one security dimension relating to security of the distributed processing system; and at least one privacy dimension relating to data privacy for data processed by the distributed processing system. One or more of the impact dimensions may be associated with respective sub-dimensions.

The selecting step of the method may comprise computing a weight for each impact dimension based on the one or more input parameters associated with the impact dimension. The method may comprise applying predetermined scaling operations to one or more of the input parameters and using the scaled input parameters in computing the weights. The method may comprise computing a weight for a given impact dimension based on respective input parameters defined for respective sub-dimensions associated with the impact dimension. The method may comprise normalising the weights computed for the impact dimensions.

The selecting step may comprise, for each predetermined process stage: computing, for each process module available for implementation of the process stage, a dimension score for each of a plurality of impact dimensions based on the computed weights for the impact dimensions and the corresponding impact attributes defined for the process module for those impact dimensions; and selecting a process module for the process stage based on the dimension scores. The method may comprise computing a total score for each process module available for implementation of the process stage based on the dimension scores, and selecting a process module for the process stage based on the total scores. The method may comprise selecting a process module having the highest total score.

The method may comprise modifying one or more of the computed weights based on prioritisation information indicating one or more dimensions to be prioritised. The prioritisation information may be received from a user via a user interface. This can allow a user's preferences for certain impact dimensions to be taken into account when selecting the modules for implementing a consensus process. The method may comprise outputting a representation of the computed weights to a user via a user interface, receiving updated prioritisation information via the user interface, and recomputing the weights based on the input parameters and the updated prioritisation information. This can provide flexibility to the method, allowing a user to adjust the selection of modules for implementing a consensus process according to their preferences.

The consensus process may be arranged to determine consensus between nodes of the distributed data processing system for recording one or more transactions, optionally a block of transactions, in a distributed database of the distributed data processing system. The distributed database may comprise a distributed ledger system or blockchain.

The consensus process stages may comprise one or more, preferably each, of: an election stage for electing a system node as a leader node or a proposer node to lead the consensus process; a request stage for submitting a request for recording one or more transactions to the system; a pre-prepare stage for processing the transaction request at the leader node or proposer node; a prepare stage for verifying the one or more transactions by one or more validator nodes; a commit stage for recording the one or more transactions at the validator nodes; and a decide stage for finalising the one or more transactions at the leader node or proposer node.

The process modules for the election stage may comprise one or more of: a voting module for defining a voting process wherein system nodes vote for a leader node; a predetermination module for defining a predetermined leader node; a round-robin module for defining a predetermined order of a group of the system nodes for taking turns as a leader node; and a proposer module for defining a proposer node to propose transactions to the system. The voting module may define a threshold percentage of votes required in order to be elected as the leader node. The voting module may define that the voting process times out after a predetermined period of time. The proposer module may define a proposer node to propose transactions using a proof-of-work or proof-of-stake mechanism.

The process modules for the request stage comprise one or more of: a to-one module for sending a transaction request to a selected one of the system nodes; a to-all module for sending a transaction request to a plurality of the system nodes (e.g. to all system nodes participating in the consensus process).

The process modules for the pre-prepare stage may comprise one or more of: a proof-of-X module for publishing the one or more transactions by the leader node or proposer node based on a proof-of-X approach; a verification module for verifying, by the leader node, one or more proposed transactions; an inter-communication and verification module for enabling the leader node to communicate with other system nodes and to filter transactions; and a no-action module for defining that the leader node or the proposer node take no action. The proof-of-X approach may be a proof-of-Work or proof-of-Stake approach. The verification module may be for verifying the one or more proposed transactions by comparing an input of each transaction with an output of the respective transaction.

The process modules for the prepare stage may comprise one or more of: a voting module for enabling validator nodes to vote for a transaction request; an inter-communication and voting module for enabling validator nodes to communicate with each other and vote for a transaction request; and a no-action mode for defining that the validator nodes take no action.

The process modules for the commit stage may comprise one or more of: a data backup module for storing a backup copy of the one or more transactions in a database of one or more validator nodes; an inter-communication and data backup module for enabling validator nodes to communicate with each other before storing a backup copy of the one or more transactions; a no-action module for defining that the validator nodes take no action.

The process modules for the decide stage may comprise one or more of: a backup reply threshold module for finalising the one or more transactions at a leader node and responding to a node that submitted the request in response to the leader node receiving backup replies from a threshold proportion of the validator nodes; a vote reply threshold module for finalising the one or more transactions at a leader node and responding to a node that submitted the request in response to the leader node receiving vote replies from a threshold proportion of the validator nodes; a self-decision module for enabling the leader node to decide independently of other nodes whether to finalise the one or more transactions; and a no-leader module for enabling a proposer node to submit one or more transactions to the system (e.g. without use of a leader module).

The selecting step may comprise, for the prepare stage and/or the commit stage, configuring one or more selected modules and/or the consensus process implementation to: select all of the system nodes that are not the leader node as validator nodes; or select a subset of the system nodes that are not the leader node as validator nodes. The subset of system nodes may be selected dynamically. A dynamically selected set of validators can allow for a flexible set of participants as validator nodes in the consensus process, enabling improved performance of its implementation. Selecting all of the non-leader nodes or a fixed subset of non-leader nodes as validator nodes can be easier to implement and provide greater security.

The selecting step may comprise, for one or more of the process stages, selecting whether to add an encryption module to the process implementation of that stage. The encryption module may be for encrypting communications between nodes of the distributed data processing system. The encryption module can improve the security of the consensus process implementation.

The method may comprise outputting an indication of the implementation specification and/or the selected process modules to a user via a user interface. The method may comprise modifying one or more module selections in response to user input. This can allow a user to manually adjust the consensus process implementation, thus providing greater flexibility. The method may comprise receiving modified implementation criteria from the user via the user interface and repeating the steps of selecting modules and generating an implementation specification based on the modified implementation criteria.

The distributed data processing system may comprise a distributed database or distributed ledger system. The distributed ledger system may be a blockchain system. The consensus process may be arranged to determine consensus between nodes of the system when recording one or more transactions, or a block of one or more transactions, to the distributed database, ledger or blockchain.

The method may comprise generating a respective consensus process implementation for each of a plurality of sub-networks of the distributed data processing system. The sub-networks may be specified in the implementation criteria or in the information defining a target operating architecture. The method may comprise repeating the steps of selecting process modules and generating an implementation specification, and optionally the steps of generating code and/or deploying the code, for each of the plurality of sub-networks.

The method may be performed by an application running at a client device and/or server device. The application may be a web application.

There are also described herein one or more computer programs, computer program products, and non-transitory computer-readable media comprising software code adapted, when executed by a data processing system, to perform any method as described herein.

There is also described herein a computer system having means for performing any method described herein. The means for performing may comprise one or more processors with associated memory.

Any system feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE FIGURES

Certain embodiments of the invention will now be described by way of example only, in relation to the Figures, wherein:

FIG. 1 shows a diagram of a consensus algorithm generation system in overview;

FIG. 2 shows a diagram of an example blockchain digital ledger system having a two-tier architecture;

FIG. 3a shows a diagram of a method for generating a consensus algorithm implementation for a target environment;

FIG. 3b shows a diagram of a method for generating a proposed consensus algorithm;

FIG. 3c shows a diagram of a method for computing one or more dimension weights;

FIG. 3d shows a diagram of a method for selecting a plurality of algorithm modules;

FIG. 4a shows a table illustrating an example application of a method for computing dimension weights;

FIG. 4b shows an example table of predetermined ratings;

FIG. 4c shows a table illustrating an example application of a method for selecting algorithm modules;

FIG. 5 shows a diagram of an example consensus process;

FIG. 6a shows a diagram of an example consensus process and the available algorithm modules at each stage of the consensus process;

FIGS. 6b and 6c each show a diagram of an example set of proposed consensus algorithm modules, corresponding to the consensus process of FIG. 6a;

FIG. 7a-7c show example user interfaces; and

FIG. 8 shows an example hardware and software implementation of a server.

### DETAILED DESCRIPTION

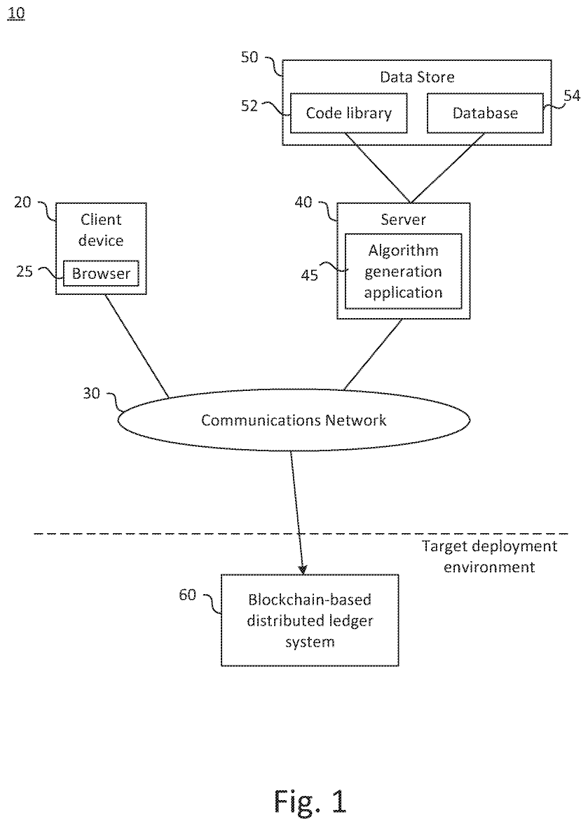

FIG. 1 illustrates an example system 10 for generating and implementing a consensus algorithm. The term “consensus algorithm” preferably refers to any algorithm used for establishing consensus between nodes in a distributed ledger (e.g. blockchain) or other distributed transaction processing system, for example when committing one or more transactions, or a block of one or more transactions, to a blockchain or other distributed database. Thus, one consensus process may relate to recording one or more transactions.

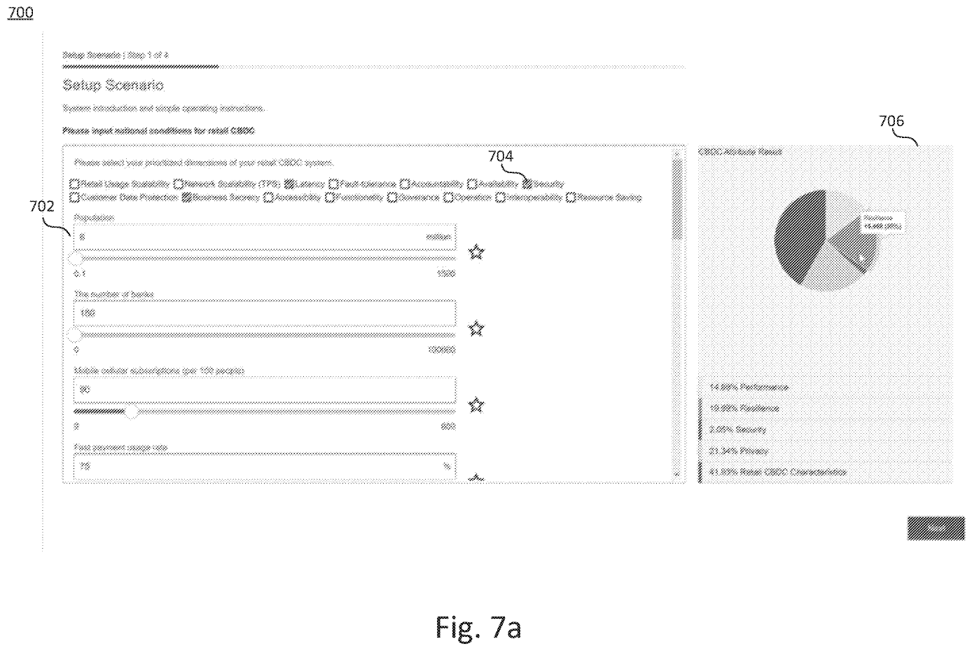

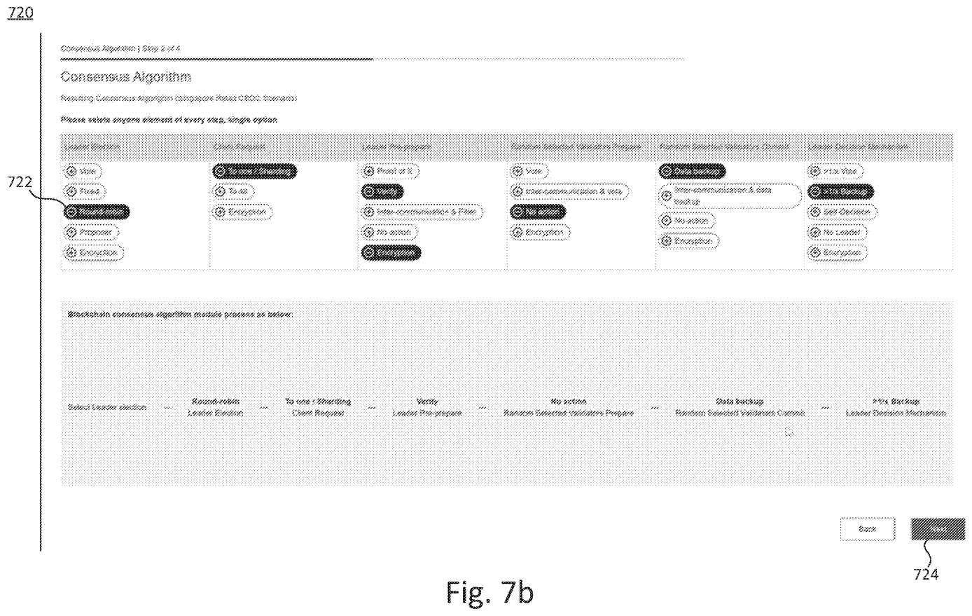

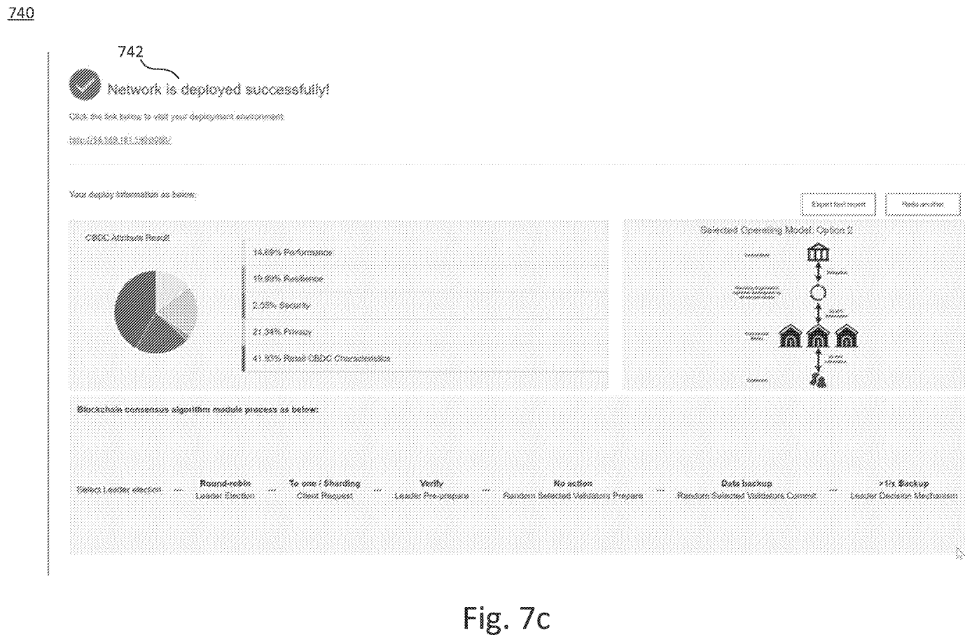

The system 10 includes a client device 20 arranged to communicate with a server 40 via a communications network 30 such as the internet. The client device 20 includes a browser 25, such as an internet browser, configured to run an algorithm generation application 45 hosted at the server 40. The user device 20 and browser 25 may provide a user interface through software and hardware via which a user may provide inputs to the application and via which outputs and/or information may be displayed to the user by the application. Examples of the user interface provided by the browser 25 are shown in FIGS. 7a-7c. The user device 20 includes one or more processors, a memory and a communications interface operable to allow communication via the communications network 30.

Although FIG. 1 shows the application 45 as being hosted on a single server 40, in other examples the application 45 may be hosted over a plurality of servers, one or more of which the client device 20 can communicate with via the communications network 30. Furthermore, instead of a web application the application could be provided as a native application on the client device.

The server 40 is configured to communicate with a data store 50, which includes a code library 52, and a database 54. The data store 50 may be implemented on a single entity (such as a server), or over multiple entities. Accordingly, the code library 52 and the database 54 may be stored at the same entity or location, or at separate entities or locations.

The server 40 is also arranged to communicate with a target deployment system 60 in a target deployment environment via the communications network 30. In the example of FIG. 1, the target deployment system 60 is shown as a blockchain-based distributed ledger system, but in other examples it may be any type of distributed ledger system or distributed transaction processing system. The server 40 is configured to send code generated by the algorithm generation application 45 to the target deployment system 60 via the communications network 30. The code generated by the application 45 is deployed at the target deployment system 60 in order to implement a consensus algorithm.

In some examples, the client device 20 is also configured to communicate with the target deployment system 60. Alternatively or additionally, the client device 20 may form part of the target deployment system 60. For example, the client device 20 may be a user terminal at an entity in the target deployment system 60 for which the implementation of a consensus algorithm is sought.

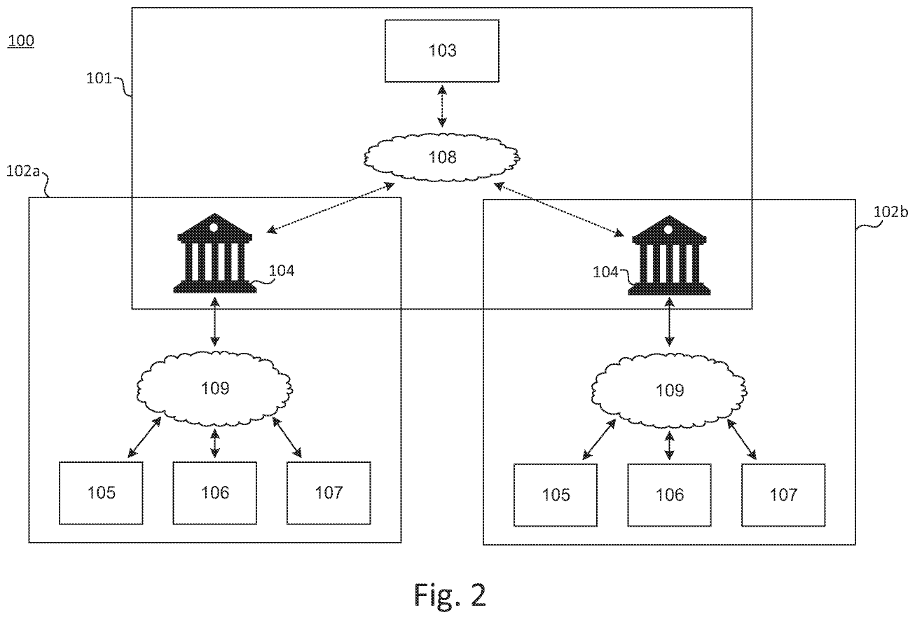

FIG. 2 Illustrates an example blockchain-based distributed ledger system 100. In the example embodiment, the blockchain system is a system for distribution and exchange of digital tokens, especially value tokens, such as digital currency tokens. The term “token” as used herein preferably refers to any digital representation of value, or of some other asset, that is stored and/or exchanged by the distributed ledger system. Such tokens could, for example, be in the form of Unspent Transaction Outputs (UTXO) or similar. However, the described principles may be applied to other types of blockchain systems and other distributed transaction processing systems. For example, the described principles may be implemented using account-based digital currency systems.

The system 100 has a two-tier architecture, including networks 101, 102a and 102b for managing the exchange and distribution of tokens. The term “architecture” or “operating architecture” preferably refers to a structure that defines the roles of and relationships between entities in a network or system.

In some examples, the system 100 may be used as a target deployment system for consensus algorithm deployment, such as the target deployment system 60 of FIG. 1.

Network 101 is a tier-1 network. In some examples, the network 101 can be a wholesale network such as a wholesale central banking digital currency (CBDC) network. The term “central bank digital currency” preferably refers to a digital representative of fiat currency, or a digital currency which is independent of and/or alternative to fiat currency.

The network 101 can include a control node 103, such as a central bank, which is communicably connected via a communication network 108 to one or more tier-1 entities 104 (for example other banking institutions). The network 101 handles the exchange of tokens between the control node 103 and the one or more tier-1 entities 104.

The system 100 includes at least two tier-2 networks 102a, 102b. In some examples, the system can have only one tier-2 network, or more than two tier-2 networks. One or both of the tier-2 networks 102a, 102b can be a retail network such as a retail CBDC network. Each tier-2 network 102a, 102b includes one of the tier-1 entities 104 communicably connected via a communication network 109 to tier-2 entities 105-107 such as retail clients Including individual users, households or businesses. The tier-2 network 102a, 102b handles the exchange of tokens between tier-2 entities 105-107 and between tier-2 entities and tier-1 entities 104. In each tier-2 network 102a, 102b, the tier-1 entity 104 may act as a control node for the tier-2 network. Thus, the tier-1 entities 104 may also be referred to as tier-2 control nodes.

The term “tier-1” generally refers to parts of a transaction processing system with greater privileges and/or responsibilities, such as the authentication of transactions and issuing of currency, such as token-based or account-based digital currency (e.g. central bank digital currency). These parts of a transaction processing system will generally interact directly with a global control node such as a central bank.

The term “tier-2” generally refers to parts of a transaction processing system with lower or reduced privileges and/or responsibilities, but which interact directly with clients of the system, such as retail clients including individual users, households or businesses. For example, these parts of the system may not necessarily be permitted to issue currency or authenticate transactions, but may be able to perform other functionalities, such as circulating currency. The terms “tier-1” and “tier-2” are not mutually exclusive, and for example, some entities, such as the tier-1 entities 104 in FIG. 2, can have tier-1 and tier-2 properties.

Accordingly, in the two-tier system architecture of FIG. 2, the tier-1 entities 104 (e.g. banking institutions) communicate directly with the control node 103 (e.g. central bank) and the tier-2 entities 105-107 communicate directly with the tier-1 entities 104. The tier-1 entities 104 control the distribution of tokens within the system 100. For example, a tier-1 entity 104 can be adapted to assist the control node 103 with issuing tokens and/or managing client authentication for the exchange of tokens. At least some of the tier-1 entities 104 can also circulate tokens within the system. For example, these tier-1 entities 104 can enable clients to transfer tokens.

In some examples, the system 100 is associated with a territory, country or jurisdiction. For example, the control node 103, the tier-1 entities 104 and/or the tier-2 entities can be located in, operate in or be otherwise associated with the territory, country or jurisdiction. In some examples, the system 100 is a central banking digital currency (CBDC) network operating in a particular country, and the networks 101, 102a, 102b manage the exchange and distribution of digital currency in that country.

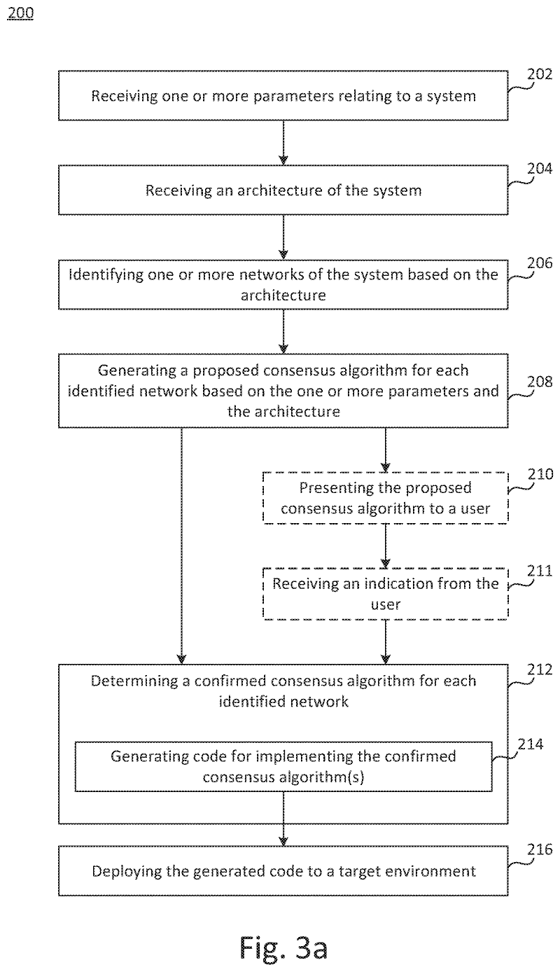

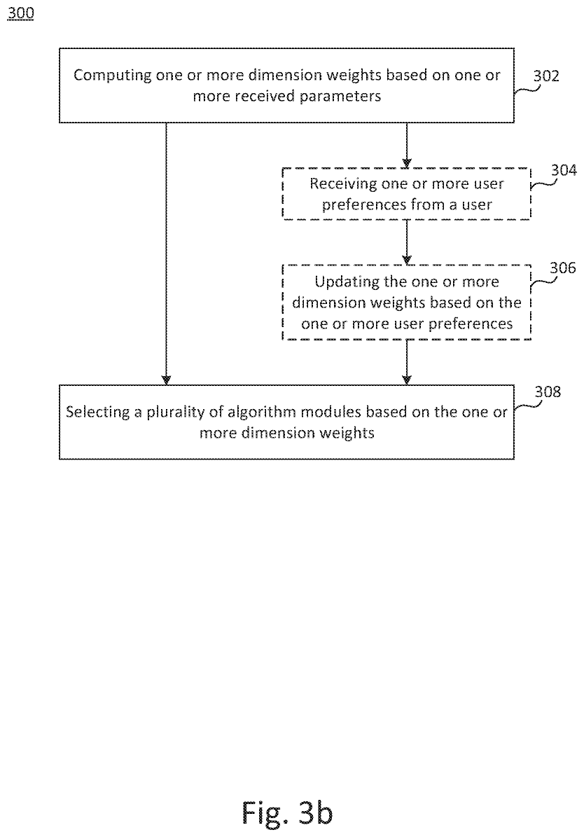

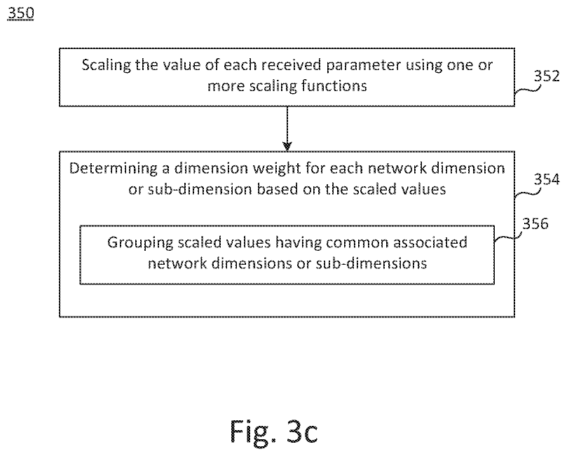

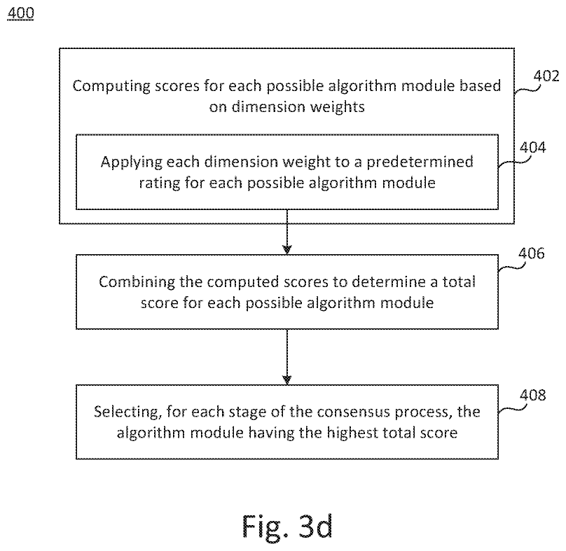

Referring to FIG. 3a, a method 200 for generating a consensus algorithm implementation for a target environment will now be described. In the described embodiments, the method 200 is performed using the consensus algorithm generation system 10 described herein, but any suitable generation system may be used. The target environment is described with reference to the blockchain-based distributed ledger system 100 described herein, but in other examples the target environment can be any system having one or more networks that use a consensus mechanism e.g. for managing the exchange and distribution of tokens. The methods described herein enable the implementation of a consensus algorithm which can allow consensus to be determined between nodes of a distributed ledger system, such as a blockchain system, when adding one or more transactions (or a block of one or more transactions) to the distributed ledger (e.g. the blockchain).

The method 200 begins with receiving 202 one or more parameters relating to the system 100. The parameters may be received from a user, for example via a user interface of client device 20, or from a database such as the database 54. The parameters may alternatively or additionally be referred to as “implementation criteria” or “index parameters”.

The one or more parameters represent characteristics of the target environment and/or requirements for the consensus algorithm. In particular, parameters may be indicative of a size or a type or architecture of the target environment, and/or performance, security and/or privacy requirements of the system 100. For example, the one or more parameters may be indicative of a user scalability, a network scalability, a transaction processing latency, fault-tolerance, data protection, information secrecy, an accessibility, a functionality, governance, operation, interoperability and/or a resource saving capability of the system 100.

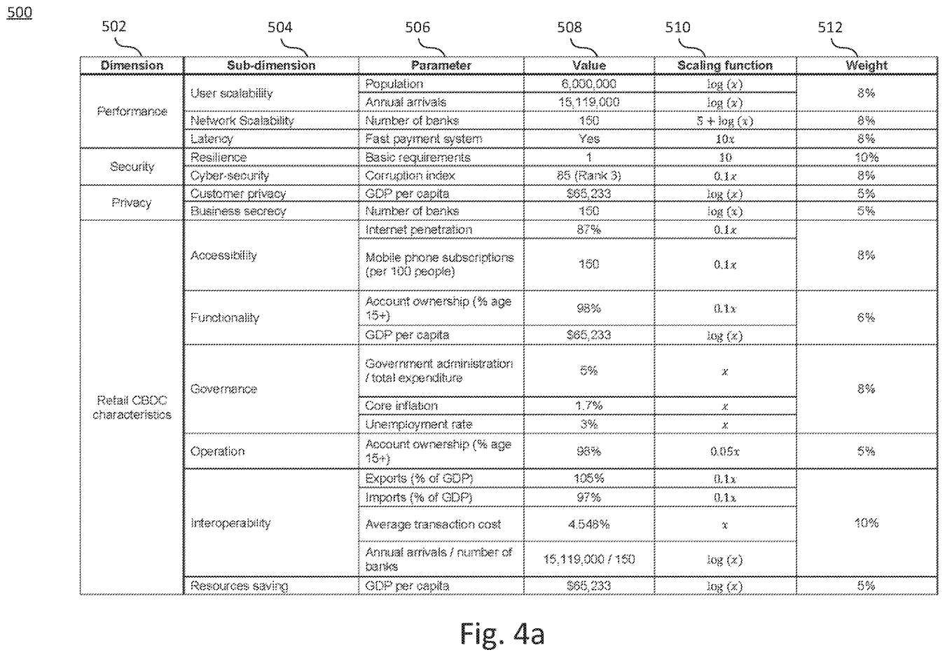

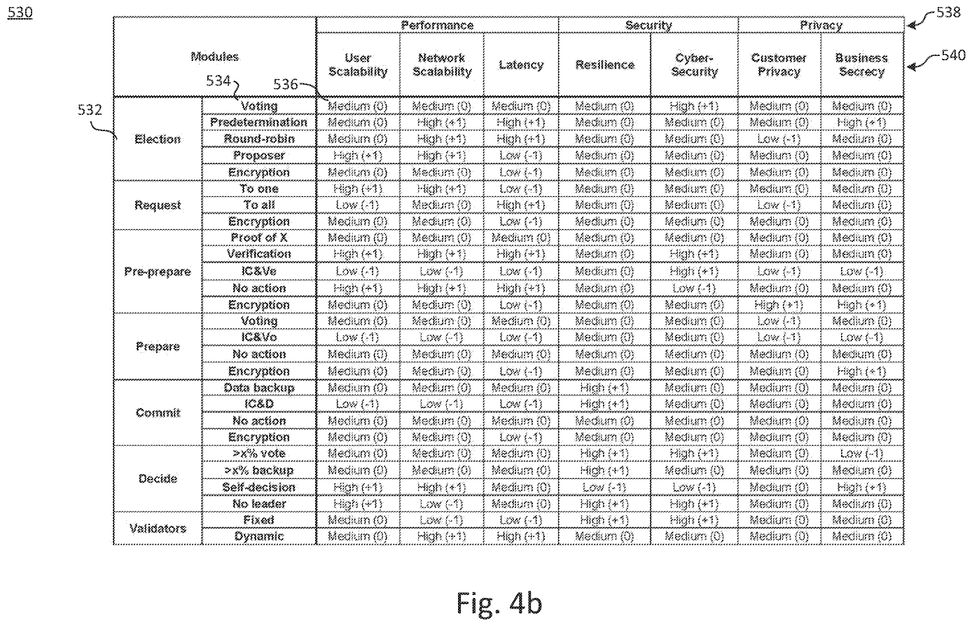

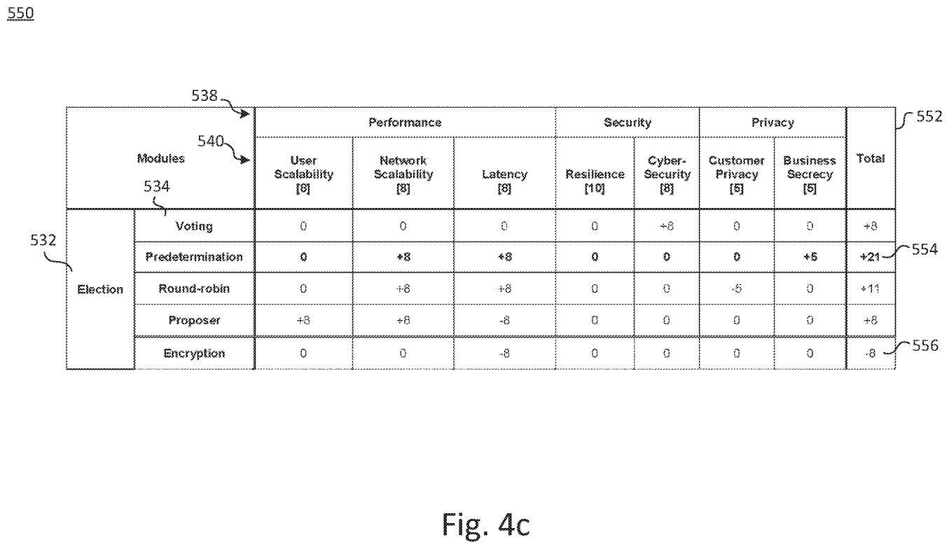

In the concrete example of a CBDC implementation, as shown in FIG. 4a, the one or more parameters may be indicative of one or more of: a (potential) user population associated with the system 100; a change in population associated with the system 100, such as a number of annual passenger arrivals; a number of tier-1 entities 104, such as a number of banks; a number of tier-2 entities 105-107, such as a number of individual users, households and/or businesses; a functionality of the system 100, such as whether the system 100 supports fast payments; a corruption index; a gross domestic product per capita; a number or proportion of internet users; a number or proportion (e.g. per 100 people) of mobile phone subscriptions; a proportion (e.g. a percentage) of clients 105-107 who are above a threshold age, such as over 15 years old; one or more economic indicators of a country, territory or jurisdiction associated with the system 100, such as an amount or proportion of government expenditure, an amount of inflation, an unemployment rate, an amount or proportion of gross domestic product associated with exports, and/or an amount or proportion of gross domestic product associated with imports; an average cost of a token transaction; and/or a ratio thereof. The specific parameters shown in FIG. 4a are purely by way of example, and any suitable set of parameters may be used depending on the application context and requirements.

The method 200 also includes the step of receiving 204 information specifying an architecture of the system 100. Although in FIG. 3a this step is shown after the step of receiving 202 one or more parameters, in some examples the architecture may be received 204 before or at the same time as receiving 202 the one or more parameters. The architecture may be received 204 at the server 40 from a user, for example via a user interface of client device 20, or it may be retrieved from a database, such as the database 54.

The received architecture indicates the structure of the system. For example, in the case of the system 100, the architecture may indicate that the system 100 has a two-tier architecture and may specify a number of networks 101, 102a, 102b present in the system 100. Optionally, in this case the architecture may also indicate a number of tier-1 entities 104 and/or a number of tier-2 entities 105-107 present within each network 101, 102a, 102b.

Next, one or more networks of the system are identified 206 based on the received architecture. For example, in the case of the system 100, the method may determine that there is one tier-1 network 101 and two tier-2 networks 102a, 102b. Additionally or alternatively, the received information specifying the architecture may also include an indication as to which of the networks 101, 102a, 102b in the system 100 require deployment of a consensus algorithm.

For each network identified at step 206, a proposed consensus algorithm is generated 208 by the algorithm generation algorithm 45 at the server 40 based on the one or more received parameters and the specified architecture. Each proposed consensus algorithm is arranged to determine consensus between nodes of the respective network, e.g. when adding one or more transactions (or a block of one or more transactions) to a distributed ledger such as a blockchain. As described in more detail below, each proposed consensus algorithm is generated in step 208 in a modular manner. The generation of a consensus algorithm is based on breaking the consensus algorithm down into a modular structure, with the system selecting one or more modules from predefined implementation modules for each of a series of process stages of the algorithm.

Optionally, after step 208, each proposed consensus algorithm is output or presented 210 to a user, for example via a user interface, and an indication is received 211 from the user. The proposed consensus algorithms may form an implementation specification which specifies one or more consensus process implementations. Thus, for each network, the implementation specification identifies the selected algorithm modules for each consensus process stage. For each proposed algorithm, the received indication can be that the user accepts the proposed consensus algorithm. Alternatively, the received indication can be that the user rejects the proposed consensus algorithm and the indication may include one or more changes to the proposed consensus algorithm in question.

For each network, a confirmed consensus algorithm is then determined 212 based on the proposed consensus algorithm. Where a proposed consensus algorithm has been presented to a user (210) and an indication has been received from that user (211), the step of determining (212) the corresponding confirmed consensus algorithm is additionally based on the indication received from the user.

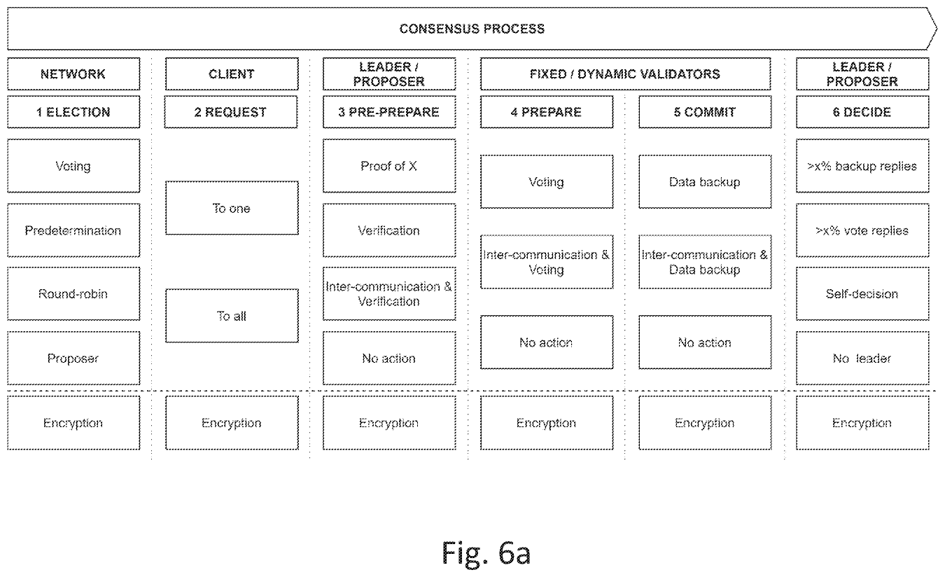

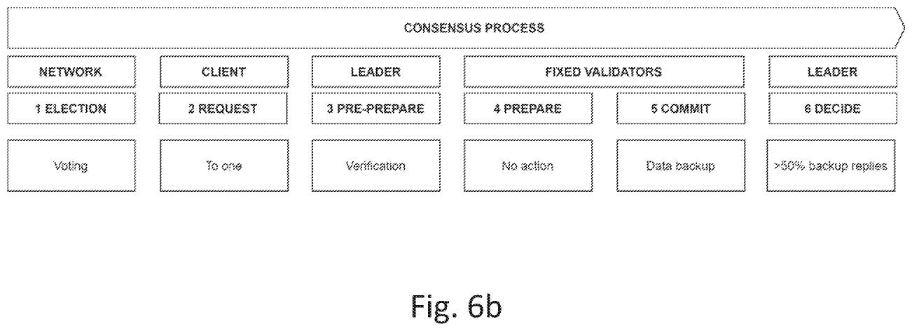

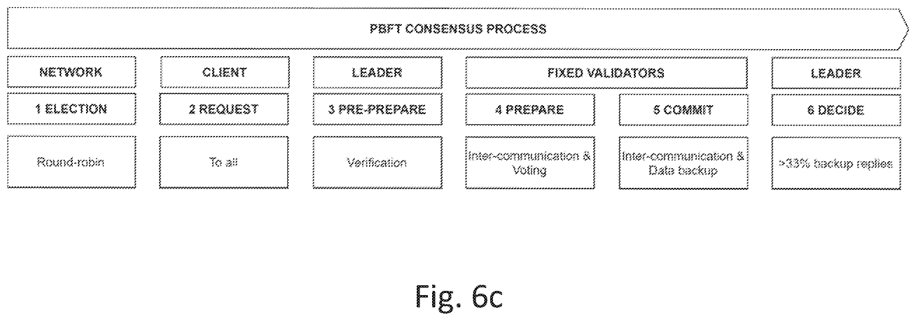

As part of step 212, the process generates an implementation specification that specifies the final design of the consensus algorithm, as proposed by the algorithm and, where required, as modified by the user. The implementation specification indicates the modules selected for inclusion in the consensus algorithm for each process stage of the consensus process. The implementation specification may, e.g., be an internal data structure defining the module selections and any other parameters/design decisions and/or may be output (e.g. to a user or another system) and/or stored in any suitable manner, e.g. in a database or as a machine and/or human-readable file (for example an XML file). The implementation specification may also be displayed to the user via the application interface (before and/or after modification by the user). FIGS. 6b-6c visually illustrate implementation specifications in the form of module selections for each process stage for two example consensus algorithms. The implementation specification may be used as the basis for subsequent steps such as code generation/deployment as discussed below.

In some examples, the step 212 includes the step 214 of generating code to implement the confirmed algorithm. Generating code is based on a library of code modules corresponding to modules of the one or more confirmed consensus algorithm. Referring to FIG. 6a, in an embodiment, the system 10 includes a code library 52 in which implementations of each of the alternative modules available for each of the consensus process stages are stored. For example, for the “election” stage, alternative module implementations for “voting”, “predetermination”, “round-robin” and “proposer” modules are stored in the library. Additional code modules are provided for other functions, including encryption and supporting libraries. An overall consensus process code template may also be provided which is adapted during code generation to invoke the selected modules. The code modules for alternative module implementations may use common module interfaces, allowing them to be combined more easily into a single consensus process implementation. When generating code at step 214, the system selects the module code for the relevant implementations of each module selected by the system for inclusion in the consensus algorithm and outputs a set of code artefacts for implementing the consensus process. In some cases, these code artefacts may then still need to be adapted by the user, for example to adapt the code for use in a specific operating environment or platform or modify the process implementation to meet additional requirements. However, in some cases, fully automated code generation may also be performed.

The generated code is then deployed at step 216 to a target environment. In an embodiment, the target environment is the target environment of FIG. 1, such as the blockchain-based distributed ledger system 60, and the deployment of the generated code Includes deploying the generated code for each confirmed consensus algorithm to the respective network in the system 60. In some examples, deploying generated code includes compiling (if necessary) and/or sending output code artefacts, which may be adapted for use in a specific operating environment or platform or modified to meet additional requirements, to one or more nodes of the system 60 in the target environment, such as a tier-1 control node 103 or tier-2 control node 104.

The deployment of generated code at step 216 may be automatic, or it may be manual. For example, the code generated at step 214 may be automatically output or sent to a controller or other node of the target deployment environment. Alternatively, the generated code may be stored, for example in the data store 50 by the algorithm generation application 45, and can be retrieved by one or more controllers, control nodes or other nodes in the target deployment environment. For example, once code has been generated for implementing the confirmed consensus algorithm for a tier-1 network in a blockchain-based distributed ledger system 60, a control node of the tier-1 network may request or access (e.g. by downloading via the communications network 30) the generated code from the server 40 and/or data store 50 based on a user command or input. Upon receipt of the generated code, the control node (and/or other nodes in the tier-1 network) run the generated code using one or more processors in order to implement the confirmed consensus algorithm at the tier-1 network. A confirmed consensus algorithm can be implemented in a similar manner at a tier-2 network of such a system.

In some embodiments, following successful deployment of the generated code, an indication is provided to a user, e.g. via a user interface on the client device 20 and/or browser 25, that the generated code has been successfully deployed for the implementation of the consensus algorithm(s).

If at step 206 more than one network or sub-network has been identified, e.g. if the system architecture received at step 204 specifies a plurality of networks and/or sub-networks, steps of the method 200 (e.g. steps 208 to 216) are repeated in order to determine and deploy a consensus algorithm implementation for each network and/or sub-network.

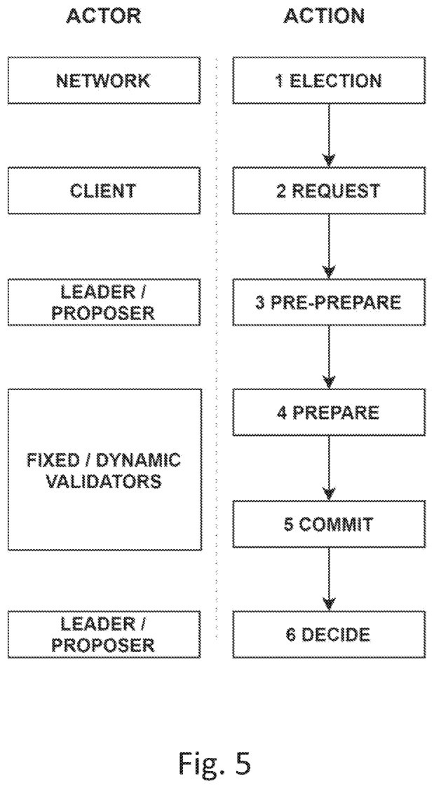

In an embodiment, the consensus algorithm is divided into six distinct process stages, and each stage is associated with one or more modules providing alternative implementations of that stage. Preferably, the consensus process is arranged to determine consensus between nodes of a blockchain system when adding one or more transactions (or block of one or more transactions) to the blockchain. As illustrated in FIG. 5, a predetermined set of such stages includes: “Election”, “Request”, “Pre-prepare”, “Prepare”, “Commit” and “Decide”. As shown in the example of FIG. 5, these stages are performed by different actors:
1. Election: a network requires one node in the network to be elected as a leader node or a proposer node in order to lead the consensus process before a client sends a transaction request
2. Request: a client submits a transaction request to the network, where the request is for recording one or more transactions.
3. Pre-prepare: the leader node or proposer node processes the transaction request locally after receiving it
4. Prepare: validator nodes in the network vote and communicate with other validator nodes to verify the transaction(s). Validator nodes are non-leader nodes in the network that can participate in the consensus process.
5. Commit: each validator node records the one or more transactions in its database
6. Decide: the leader node or proposer node finalises the transaction(s) (such that the transaction is deemed successful and will be admitted by each node in the network).

FIG. 6a shows examples of a range of available implementation modules associated with each of the stages. FIG. 6a also shows additional options considered by the system 10 when generating the consensus algorithm. For example, as shown in FIG. 6a, these options can include:
(A) Fixed/Dynamic Validators: some consensus algorithms require all nodes to participate in the consensus process, while others need selected or random dynamic nodes. A set of dynamic validators can improve performance by allowing more flexible participation in the consensus process. In contrast, fixed validators are easier to implement and more secure.
(B) Encryption: using encryption at the different stages of the consensus process can allow information to be transmitted securely at the cost of reduced performance. For example, communications between nodes of the distributed transaction processing system may be encrypted for one or more of the consensus process stages.

Therefore, for the example consensus processes of FIGS. 5 and 6a, the step 208 of generating a consensus algorithm for each identified network includes selecting, for each stage of the consensus process, an algorithm module based on the one or more parameters and the architecture. Optionally, the step 208 can also include selecting, for each stage of the consensus process, whether encryption is to be performed and/or, for stages 4 and 5 of the process, selecting whether fixed validators or dynamic validators are to be used in the algorithm.

In the example consensus process shown in FIG. 6a, for the “Election” stage of the consensus process, the algorithm module may be selected from:
i) Voting: the network nodes vote for the leader node. This can include defining voting mechanism requirements, such as a threshold percentage of votes in order to become the leader node. The voting process may time out after a predetermined period of time.
ii) Predetermination: the leader node is predetermined
iii) Round-robin: a group of nodes in the network take turns as the leader node in a specified order
iv) Proposer: the network has no leader. Instead, a proposer node collects one or more transactions from clients and proposes them to the network, for example using a proof-of-work or proof-of-stake mechanism.

In the example consensus process shown in FIG. 6a, for the “Request” stage of the consensus process, the algorithm module may be selected from:
i) To one: a client sends the transaction request to only one node in the network. This option can leverage sharding to improve system performance, whereby multiple nodes process transactions in parallel and interact with each other in a specific manner.
ii) To all: a client sends the transaction request to all nodes in the network to ensure one node accepts the request in time.

In the example consensus process shown in FIG. 6a, for the “Pre-prepare” stage of the consensus process, the algorithm module may be selected from:
i) Proof of X: the leader node or proposer node leverages a proof-of-X approach, such as Proof of Work or Proof of Stake, to publish transactions
ii) Verification: the leader node verifies proposed transactions specifically, for example checking that the input tokens equal the output tokens of the transaction
iii) Inter-communication & Verification (IC&Ve): the leader node communicates with other nodes in the network and filters transactions. Filtration can reduce the number of illegal transactions.
iv) No action: the leader node or the proposer node take no action.

In the example consensus process shown in FIG. 6a, for the “Prepare” stage of the consensus process, the algorithm module may be selected from:
i) Voting: validator nodes vote for the request
ii) Inter-communication & Voting (IC&Vo): validator nodes communicate with each other and vote for the request. This can improve the ability to prevent malicious transactions
iii) No action: validator nodes take no action.

In the example consensus process shown in FIG. 6a, for the “Commit” stage of the consensus process, the algorithm module may be selected from:
i) Data backup: validator nodes store a backup copy of the transaction(s) in their own local databases.
ii) Inter-communication & Data backup (IC&D): validator nodes communicate before backing up a copy of the transaction(s).
iii) No action: validator nodes take no action.

In the example consensus process shown in FIG. 6a, for the “Decide” stage of the consensus process, the algorithm module may be selected from:
i) >x% backup replies: the leader node only finalises the transaction(s) and responds to the requesting client once it has received backup replies from more than x% of the validator nodes. For example, the leader node may wait until it receives more than 50% of backup replies before finalising the transaction(s) and responding to the client.
ii) >x% vote replies: the leader node only finalises the transaction(s) and responds to the requesting client once it has received vote replies from more than x% of the validator nodes.
iii) Self-decision: the leader node decides whether to finalise the transaction(s) by itself. For example, the leader node may verify the one or more transactions itself.
iv) No leader: the network has no leader. Instead, the proposer node submits one or more transactions to the network, for example using a proof-of-work or proof-of-stake mechanism.

For modules (I) and (ii) above, the value of x may be configurable by a user via a user interface of the client device 20. For example, x may be received from the user via an interface (e.g. of the client device 20 and/or browser 25), or it may have a predetermined default value (e.g. 50%) which the user can adjust via the interface. Alternatively, the value of x may be determined automatically by the algorithm generation application 45 based on the one or more received parameters.

The modules which are available for each consensus process stage may vary for different networks. In particular, the available modules may be determined based on the system architecture received at step 204. For example, if the system architecture specifies one or more networks having a control node with specific requirements (e.g. a central bank that requires regulation of transactions), some process modules (e.g. “Proposer” or “Round-robin” for an “Election” stage), may not be available for those networks.

The various algorithm modules and options selected for each network in the system thus form the basis of the corresponding proposed consensus algorithm.

Referring to FIG. 3b, a method 300 for generating a proposed consensus algorithm for a network will now be described. In some examples, the step 208 of method 200 comprises the method 300, and/or the network is a network 101, 102a, 102b of the system 100. The method 300 is performed by the algorithm generation application 45 at the server 40 in system 10 described herein.

The method 300 begins by computing 302, based on one or more received parameters, one or more dimension weights. In some examples, the one or more received parameters are those received at step 202 of the method 200.

Each dimension weight indicates a significance of a corresponding network dimension or sub-dimension for generating a consensus algorithm. In some examples, the one or more dimension weights are scalar values, such as percentages or integer values. In some examples, each dimension weight may be selected from a predetermined group of categories, such as “High”, “Medium” or “Low”, and/or may be indicative of a priority level.

The network dimensions include “Performance”, “Security” and “Privacy”. In some examples, the network dimensions also include characteristics of the network regarding its specific use. For example, if the network is part of a retail CBDC system, the network dimensions may include a “Retail CBDC Characteristics” dimension.

Optionally, within each network dimension, there may be one or more network sub-dimensions. For example, a “Performance” network dimension can include a “Retail Usage Scalability” sub-dimension, a “Network Scalability” sub-dimension, and/or a “Latency” sub-dimension. A “Security” network dimension can include a “Fault-tolerance” sub-dimension. A “Privacy” network dimension can include a “Customer Data Protection” sub-dimension and/or a “Business Secrecy” sub-dimension. A “Retail CBDC Characteristics” network dimension can include an “Accessibility” sub-dimension, a “Functionality” sub-dimension, a “Governance” sub-dimension, an “Operation” sub-dimension, an “Interoperability” sub-dimension, and/or a “Resources Saving” sub-dimension.

Each of the one or more received parameters is associated with one or more network dimensions, optionally also with one or more network sub-dimensions. In some examples, a received parameter which is indicative of a population of the system which the network is part of may be associated with a “Performance” dimension and a “Retail Usage Scalability” sub-dimension. In some examples, a received parameter indicative of a number of banks within the network (or within the system) may be associated with the “Performance” and “Security” dimensions, and with “Network Scalability” and “Business Secrecy” sub-dimensions.

In some examples, the step of computing 302 the one or more dimension weights includes scaling the one or more received parameters via a set of scaling functions. Each received parameter is input to one of the scaling functions to compute a corresponding parameter weight. Each scaling function is a linear, logarithmic or constant function, or any combination thereof. The scaling functions used in an embodiment are shown in FIG. 4a. Additionally or alternatively, weights may be normalised, for example such that the values of all computed parameter weights always sum to a constant value (e.g. 1).

For each network dimension or sub-dimension, all of the computed parameter weights for parameters associated with that dimension or sub-dimension are combined to produce the corresponding dimension weight. For example, the parameter weights for parameters associated with each dimension or sub-dimension are summed to produce the corresponding dimension weights. Where dimension weights are computed for multiple sub-dimensions associated with a network dimension, those dimension weights can be combined (e.g. summed) to produce a dimension weight indicating the significance of that network dimension.

Optionally, after computing 302 the one or more dimension weights, the method 300 may include receiving 304 one or more user preferences from a user, for example via a user interface of the client device 20 and/or browser 25. These user preferences are indicative of a preference of the user towards (and/or against) one or more network dimensions or sub-dimensions. In some examples, the one or more user preferences can be indicative of one or more network dimensions or sub-dimensions that should be prioritised when generating a consensus algorithm. For example, a user may select, e.g. via the user interface 700 shown in FIG. 7a, one or more dimensions or sub-dimensions (e.g. “Performance” and “Privacy”) that they wish to be prioritised over other dimensions or sub-dimensions. In some examples, the user preferences are received at the same time as the parameters.

The method 300 then proceeds by updating 306 the one or more dimension weights based on the one or more user preferences. In some examples, the step 306 of updating the one or more dimension weights includes increasing (or decreasing) by a predetermined amount the computed value of each dimension weight for which the user has specified a preference towards (or against). Additionally or alternatively, only the computed weights corresponding to dimensions or sub-dimensions for which the user has indicated a preference may be used, and computed weights corresponding to the remaining dimensions or sub-dimensions are discarded.

Alternatively, in some examples the one or more dimension weights are determined based on the user preferences only. For example, the computed dimension weights may be used by default, but if user preferences are received (e.g. via the client device 20 and/or browser 25), all of the dimension weights computed at step 302 are discarded and the one or more dimension weights are re-computed using only the user preferences.

Next in the method 300, an algorithm module is selected 308 for each stage of the consensus process based on the one or more dimension weights. The selected algorithm modules together form the proposed consensus algorithm. The step 308 includes, for each stage of the consensus process, using the dimension weights to optimise over the network dimensions in order to identify an algorithm module for implementing that stage.

An example method 350 for computing one or more dimension weights is illustrated in FIGS. 3c and 4a. In some examples, the step 302 of method 300 comprises the method 350. The method 350 begins at step 352 by scaling the value of each of a plurality of received parameters using a scaling function. In an embodiment, the received parameters 506 can include those shown in the table of FIG. 4a and may have the corresponding values 508 shown. The scaling functions 510 can be predetermined and may be stored in memory, such as the database 54 of FIG. 1. By way of example, in the embodiment of FIG. 4a, the value of the received “population” parameter is 6,000,000 which is scaled using a logarithmic scaling function “log (x)”, where x is the parameter value. Different parameters may be scaled using the same scaling function or different scaling functions. In some examples, the weights are additionally or alternatively normalised, e.g. such that the scaled values sum to a constant value such as 1 (or 100%).

Next, at step 354, dimension weights 512 are determined based on the scaled values calculated in step 352. Each received parameter may be associated with more than one network dimension 502 or sub-dimension 504. For instance, as shown in FIG. 4a, the “Number of banks” parameter is associated with a “Network scalability” sub-dimension (within the “Performance” dimension) as well as a “Business secrecy” sub-dimension (within the “Privacy” dimension). In the example of FIG. 3c, step 354 can include the step 356 of grouping these scaled values according to their associated network dimensions or sub-dimensions. At step 356, the scaled values determined at step 352 for parameters having a common associated sub-dimension (or dimension) are grouped or combined to determine the dimension weight 512 for that sub-dimension (or dimension). For example, in the embodiment of FIG. 4a, the “Population” and “Annual arrivals” parameters are both associated with the “User scalability” sub-dimension (within the “Performance” dimension). At step 352, their values are scaled using the scaling function “log (x)”, producing scaled values 6.78 and 7.18 respectively, which are combined (and scaled) at step 354 (including step 356) to produce a weight for the “User scalability” sub-dimension. Weights for each network sub-dimension and/or dimension are determined in this manner. Optionally, once scaled and combined as needed, the final dimension weights may be normalised to produce normalised weights. For example, the scaled values for the “Population” and “Annual arrivals” parameters may be combined at step 354 to produce a weight, which in turn is scaled to produce a percentage value of 8% for the “User scalability” sub-dimension weight, as shown in FIG. 4a. The weight values for all of the weights (combined as needed) may then be normalised (not shown in FIG. 4a), e.g. such that the normalised weights sum to a constant value such as 1 (or 100%).

An example method 400 for selecting a plurality of algorithm modules is illustrated in FIG. 3d. In some examples, the step 308 of method 300 comprises the method 400. The method 400 begins at step 402 by, for each stage of the consensus process, computing scores for each algorithm module based on dimension weights, such as those computed in step 302. In particular, a score is computed for each of the possible algorithm modules with respect to each network dimension corresponding to the dimension weights. In some embodiments, computing the scores includes, for each possible algorithm module, the step 404 of applying (e.g. by multiplication) each dimension weight to a predetermined rating defined for the particular algorithm module and for the same dimension or sub-dimension as that weight.

Next, at step 406, for each possible algorithm module at each stage of the consensus process, the scores computed at step 402 (or step 404) are combined (e.g. by summation) to determine a total score. A plurality of algorithm modules is then selected at step 408 by, for each stage of the consensus process, selecting the algorithm module having the highest total score.

Alternatively, in some embodiments the step 308 includes optimising over all possible combinations of algorithm modules using the dimension weights in order to select the algorithm modules that form the proposed consensus algorithm. In this case, the plurality of algorithm modules is selected by, for each possible combination of algorithm modules providing a complete consensus process, computing scores for each constituent algorithm module based on the dimension weights, for example by applying each dimension weight (e.g. by multiplication) to a predetermined rating corresponding to the same dimension or sub-dimension as that weight. A total score for each possible combination of algorithm modules is computed by combining the determined scores and selecting the combination of algorithm modules with the highest total score.

The predetermined ratings used in step 404 are stored in memory, for example at the database 54 of the system 10. In some embodiments, the predetermined ratings are stored formatted in a table (e.g. a look-up table), an example of which is shown in FIG. 4b. In this example, the table 530 contains, for each possible alternative algorithm module 534 at each stage 532 of a consensus process, an associated predetermined rating 536 under each of a plurality of network dimensions 538 and/or sub-dimensions 540. Each predetermined rating is indicative of a degree to which a given algorithm module impacts (or is expected to impact) a given network dimension or sub-dimension in a deployed system. For example, as shown in FIG. 4b, each predetermined rating may be a category selected from a group comprising “High”, “Medium” or “Low”. In this example, “High” means the module has a relatively positive impact on the network dimension or sub-dimension, “Medium” means the module has no impact or relatively medium impact on the network dimension or sub-dimension, and “Low” means the module has a relatively low positive impact and/or a relatively negative impact on the network dimension or sub-dimension. For example, in the example of FIG. 4b, the “Round-robin” module for the “Election” stage of the consensus process has a “High” predetermined rating under the “Latency” sub-dimension. This means that, if selected as part of a consensus algorithm, the round-robin module provides a relatively positive, or low negative, impact to the latency of the algorithm. Specifically, this can mean that latency introduced as a result of including the round-robin module is lower than a threshold latency or latencies of a number of other modules (it should be noted that in this example “high” is used to mean a broadly positive impact in that the particular module is rated highly in respect of the “latency” dimension and thus a “high” rating for latency would denote relatively low network latency—however, the ratings could of course be defined differently). Although the network dimensions and sub-dimensions shown in the example of FIG. 4b do not include all of those shown in the table 500 of FIG. 4a, those skilled in the art will understand that any number of network dimensions and/or sub-dimensions may be used.

Additionally or alternatively, the predetermined ratings can include numerical values. In some examples, the predetermined ratings are encoded to numerical values such that they are combinable (for example by multiplication) with the dimension weights. For example, the rating categories “High”, “Medium” and “Low” can be encoded to corresponding integer values, such as +1, 0 and −1 respectively, as shown in FIG. 4b. In this case, at step 404 each score is computed by multiplying the numerical value or encoded numerical value of the predetermined rating with the corresponding dimension weight computed at step 302.

In the described examples, the rating categories are indicative of a degree to which a given algorithm module positively impacts a network dimension or sub-dimension of a consensus algorithm. Alternatively, in other examples, the categories “High”, “Medium” and “Low” may be indicative of a degree to which a given algorithm module negatively impacts a network dimension or sub-dimension of a consensus algorithm.

The method 400 is completed once an algorithm module has been selected for each stage of the consensus process in this manner. Accordingly, this method can allow for the construction of a consensus algorithm which is adapted to the specific characteristics and requirements of the network in question.

A simplified example application of the method 400 for selecting a plurality of algorithm modules as described above is illustrated in FIG. 4c. In this example, the computed scores of each possible algorithm module 534 for the “Election” stage 532 of a consensus process are shown, although the same process is carried out for each stage of the consensus process. The modules for the “Election” stage shown in FIG. 4c includes “Voting”, “Predetermination”, “Round-robin” and “Proposer” modules, as well as an optional “Encryption” module. Weights corresponding to each network sub-dimension 540 are shown in brackets next to each sub-dimension, and are based on the determined weights shown in the example of FIG. 4a. For each module 534, the scores are computed by multiplying the corresponding predetermined ratings from the table 530 of FIG. 4b with the weights shown for each network sub-dimension.

For example, the score for the “Proposer” module under the “Network scalability” sub-dimension is calculated by multiplying the encoding of the “High” rating (+1) shown in FIG. 4b by the weight for the network scalability sub-dimension (8), to produce +1×8=+8. Similarly, the predetermined rating for that module under the “Latency” sub-dimension is “Low” (encoded to −1) and the weight for the “Latency” sub-dimension is 8, so the computed score for the “Proposer” module under the “Latency” sub-dimension is −1−8 =−8.

The scores for each combination of algorithm module and network sub-dimension are computed in this way, and are summed to determine the total score 552 for each module. In the example of FIG. 4c, the “Predetermination” algorithm module is selected as the algorithm module for the “Election” stage, since it has the highest total score 554.

The optional “Encryption” module may be selected independently of the other modules for the “Election” stage. For example, “Encryption” may be selected if the corresponding total score is above a threshold value, such as 0. In this case, the “Encryption” module would not be selected in the example of FIG. 4c, since its total score is −8. The threshold value may be adjusted by a user, for example via a user interface provided on the client device 20 and/or browser 25. Additionally or alternatively, the “Encryption” module may be selected if a difference between its total score and the highest total score of the other modules for that stage is higher than the total score of any other modules for that stage. For instance, in the example of FIG. 4c, the sum of the total score for the “Encryption” module (−8) and that of the “Predetermination” module (+21) is +13, which is higher than any other module's total score, so the “Encryption” module is selected. Additionally or alternatively, the “Encryption” module may be selected based on whether network requirements, e.g. a user requirements or requirements of a certain node type, are satisfied. For example, if the leader node and validator nodes cannot share transaction information with each other (e.g. for data privacy reasons), the “Encryption” module may be selected, e.g. to enable validator nodes to record encrypted transaction data for verifying and recording the transaction without needing to access the original transaction data itself.

In some implementations, the computation described above may be performed using matrix operations, for example by multiplying a matrix of predetermined ratings (or encoded predetermined ratings) with a vector corresponding to the dimension weights to output a vector containing the total scores of the various algorithm modules. Thus, the selected algorithm module is that which corresponds to the largest element of this output vector.

When determining 308 the plurality of algorithm modules, the computation (such as that shown in FIG. 4c) is repeated for each stage of the consensus process. As shown in FIGS. 6b and 6c, a module for each consensus process stage is thus selected. For example, in FIG. 6b, a consensus algorithm is shown which has been determined using the methods described herein. This algorithm may be referred to as a “Raft” consensus algorithm, and starts with voting and an election timeout mechanism for the election stage. Then a client sends a request to the leader in the network (the “to one” module) to record one or more transactions. After the leader's verification at the pre-prepare stage, fixed validators make a backup and respond to the leader node. Then the one or more transactions will be regarded as valid when the leader receives backup replies from more than 50% of the validator nodes.

The example shown in FIG. 6c depicts a “PBFT” (practical Byzantine fault tolerance) algorithm determined using the methods described herein. First, the algorithm selects a leader in a round-robin manner. Then a client sends a request to all nodes in the network, and the leader node undertakes a simple verification and publishes the request. Then, at the “prepare” stage, fixed validators communicate to ensure more than 67% of nodes pass verification. Then a new round of communication between the validators requires more than 67% of them to undertake a data backup at the “commit” stage. Finally, the leader node waits for replies from at least 33% of the validators to ensure there is no malicious behaviour.

Example user interfaces provided on a browser, such as the browser 25 of client device 20, are shown in FIGS. 7a-7c. FIG. 7a shows an example interface 700 provided by an application, such as the algorithm generation application 45, for a user to specify parameters 702, such as those received at step 202 of the method 200, and/or dimension prioritisation information, such as the user preferences received at step 304 of the method 300. As shown in FIG. 7a, a user may specify values of parameters 702 such as “population”, “number of banks”, “mobile cellular subscriptions (per 100 people)” and “fast payment usage rate” via text inputs and/or sliders of the user interface 700. A user can also use the interface 700 to select one or more network dimensions (or sub-dimensions) which they wish to prioritise, for example by selecting one or more checkboxes 704. Although not shown, the interface 700 may also be used to receive information specifying a system architecture, such as that received at step 204 of the method 200.

In the example interface of FIG. 7a, an indication 706 of the dimension weights, such as a graph, chart and/or list, is provided to a user via the user interface 700. The indication 706 may be configured to update in real-time, such that the effect of adjusting parameters 702 and/or user preferences via checkboxes 704 can be conveyed to the user in real-time.

FIG. 7b shows an example interface 720 provided by an application, such as the algorithm generation application 45, for a proposed consensus algorithm to be presented to a user by an indication 722, for example as part of step 210 of the method 200 described herein. The indication 722 indicates which algorithm modules have been selected for each stage of the consensus process. In this example, the “Round-robin”, “To one/sharding”, “Verify”, “Encryption”, “No action”, “Data backup” and “>1/x backup” modules are marked (e.g. by shading or highlighting) to indicate that the proposed consensus algorithm consists of those modules. The interface 720 also allows the user to provide one or more indications, such as those received at step 211 of the method 200, which can provide the user with the ability to add and remove algorithm modules at each stage of the consensus process, thus allowing the user to reject and/or make changes to the proposed consensus algorithm. When the user has finished making changes or is happy with the proposed consensus algorithm, they can indicate that they wish to proceed on the basis of the displayed algorithm, e.g. by selecting a button 724.

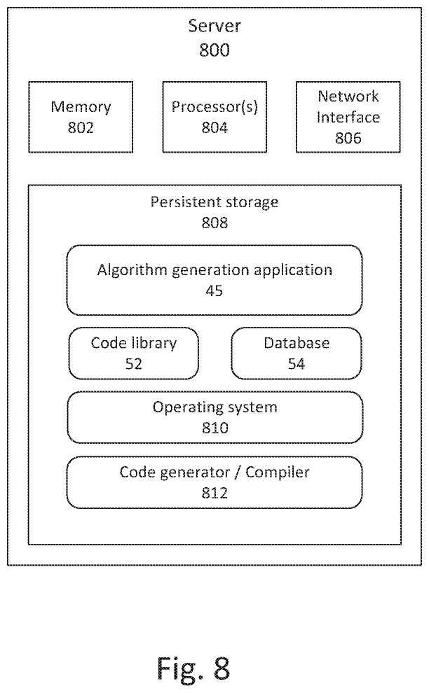

FIG. 7c shows an example interface 740 provided by an application, such as the algorithm generation application 45, for providing an indication 742 that deployment of generated code for the implementation of a consensus algorithm, such as that deployed at step 216 of the method 200, was successful. The user interface 740 optionally also provides information summarising, for each network, the confirmed consensus algorithm that has been implemented and the dimension weights and network architecture that have been used. While specific systems 10 and 100 are shown, any appropriate hardware/software architecture may be employed. For example, the transaction processing system may have a multi-tier architecture, such as a three-tier architecture. Example hardware and software implementation of a server is shown in FIG. 8. The depicted server 800 may be used to implement server 40 of FIG. 1. Server 800 includes a volatile/random access memory 802, one or more processors 804, a network interface 806 and persistent storage 808. The persistent storage 808 contains software and data for implementing the processes and functions described above, including but not limited to the algorithm generation application 45, code library 52, database 54, an operating system 810 and a code generator and/or compiler 812 for generating code for a consensus algorithm created using the algorithm generation application based on the code templates in the code library.

The above embodiments and examples are to be understood as illustrative examples. Further embodiments, aspects or examples are envisaged. It is to be understood that any feature described in relation to any one embodiment, aspect or example may be used alone, or in combination with other features described, and may also be used in combination with one or more features of any other of the embodiments, aspects or examples, or any combination of any other of the embodiments, aspects or examples. Furthermore, equivalents and modifications not described above may also be employed without departing from the scope of the invention, which is defined in the accompanying claims.

1. A computer-implemented method of implementing a modular consensus process for a distributed data processing system, the consensus process arranged to determine consensus between multiple processing nodes of the system, the method comprising:
providing a module database storing information defining, for each of a predetermined set of process stages of the consensus process, one or more process modules for use in implementing the process stage, the information specifying, for each process module, one or more impact attributes, each impact attribute indicating an expected impact of the module on operation of the distributed data processing system with respect to a respective impact dimension;
receiving a set of implementation criteria for the consensus process;
selecting, for each of the predetermined process stages of the consensus process, a given one of the process modules for implementing the process stage, the given process module selected based on the impact attributes specified for process modules in the database and the received implementation criteria; and
generating an implementation specification specifying a consensus process implementation, the specification identifying the selected process modules for each process stage.

2. A method according to claim 1, comprising:
storing in a code library a plurality of code artefacts, each code artefact for implementing a given process module; and
generating software code based on code artefacts from the library associated with the selected process modules.

3. A method according to claim 2, comprising deploying the generated software code to a target system.

4. A method according to claim 1, wherein the implementation criteria comprise information defining a target operating architecture of the distributed data processing system.

5. A method according to claim 4, wherein the information defining a target operating architecture specifies a network architecture of the distributed data processing system, specifying one or more of:
a number of sub-networks;
numbers of nodes and/or controlling nodes in the network or in one or more sub-networks;
a tiering architecture arranging sub-networks into a hierarchy.

6. A method according to claim 1, wherein the implementation criteria comprise one or more input parameters associated with the impact dimensions, the input parameters optionally received from a user via a user interface.

7. A method according to claim 6, wherein the input parameters define context characteristics relating to an operational context of the distributed processing system.

8. A method according to claim 1, wherein the impact dimensions comprise one or more of:
at least one performance dimension relating to technical performance of the distributed processing system;
at least one security dimension relating to security of the distributed processing system;
at least one privacy dimension relating to data privacy for data processed by the distributed processing system.

9. A method according to claim 1, wherein one or more of the impact dimensions are associated with respective sub-dimensions.

10. A method according to claim 6, wherein the selecting step comprises computing a weight for each impact dimension based on the one or more input parameters associated with the impact dimension.

11. A method according to claim 10, comprising applying predetermined scaling operations to one or more of the input parameters and using the scaled input parameters in computing the weights.

12. A method according to claim 10, comprising computing a weight for a given impact dimension based on respective input parameters defined for respective sub-dimensions associated with the impact dimension.

13. A method according to claim 10, comprising normalising the weights computed for the impact dimensions.

14. A method according to claim 10, wherein the selecting step comprises, for each predetermined process stage:
computing, for each process module available for implementation of the process stage, a dimension score for each of a plurality of impact dimensions based on the computed weights for the impact dimensions and the corresponding impact attributes defined for the process module for those impact dimensions; and
selecting a process module for the process stage based on the dimension scores.

15. A method according to claim 14, comprising computing a total score for each process module available for implementation of the process stage based on the dimension scores, and selecting a process module for the process stage based on the total scores, preferably comprising selecting a process module having the highest total score.

16. A method according to claim 10, comprising modifying one or more of the computed weights based on prioritisation information indicating one or more dimensions to be prioritised, the prioritisation information optionally received from a user via a user interface.

17. A method according to claim 16, comprising:
outputting a representation of the computed weights to a user via a user interface;
receiving updated prioritisation information via the user interface; and
recomputing the weights based on the input parameters and the updated prioritisation information.

18. A method according to claim 1, wherein the consensus process is arranged to determine consensus between nodes of the distributed data processing system for recording one or more transactions, optionally a block of transactions, in a distributed database of the distributed data processing system, the distributed database optionally comprising a distributed ledger system or blockchain.

19-32. (canceled)

33. A non-transitory computer-readable media-medium storing computer interpretable instructions, which when executed by a processor, cause the processor to execute a computer-implemented method of implementing a modular consensus process for a distributed data processing system, the consensus process arranged to determine consensus between multiple processing nodes of the system, the method comprising:
providing a module database storing information defining, for each of a predetermined set of process stages of the consensus process, one or more process modules for use in implementing the process stage, the information specifying, for each process module, one or more impact attributes, each impact attribute indicating an expected impact of the module on operation of the distributed data processing system with respect to a respective impact dimension;
receiving a set of implementation criteria for the consensus process;
selecting, for each of the predetermined process stages of the consensus process, a given one of the process modules for implementing the process stage, the given process module selected based on the impact attributes specified for process modules in the database and the received implementation criteria; and
generating an implementation specification specifying a consensus process implementation, the specification identifying the selected process modules for each process stage. method as set out in any of the preceding claims.

34. A computer system having a processor coupled with computer memory and a non-transitory computer readable data storage, the processor configured to:
provide a module database storing information defining, for each of a predetermined set of process stages of the consensus process, one or more process modules for use in implementing the process stage, the information specifying, for each process module, one or more impact attributes, each impact attribute indicating an expected impact of the module on operation of the distributed data processing system with respect to a respective impact dimension;
receive a set of implementation criteria for the consensus process;
select, for each of the predetermined process stages of the consensus process, a given one of the process modules for implementing the process stage, the given process module selected based on the impact attributes specified for process modules in the database and the received implementation criteria; and
generate an implementation specification specifying a consensus process implementation, the specification identifying the selected process modules for each process stage.
